(19) United States
(12) Patent Application Publication
(10) Pub. No.: US 2012/0270100 A1
(43) Pub. Date: Oct. 25, 2012

(54) Secondary battery structure

(76) Inventor: Mike Yang, Hsinchu (TW)

(21) Appl. No.: 12/458,977

(22) Filed: Jul. 29, 2009

(51) Int. Cl. H01M 2/04; H01M 2/30; H01M 2/06

(52) U.S. Cl. 429/180

(57) ABSTRACT

The present invention discloses a secondary battery structure, which comprises a battery body and two terminal assemblies. The battery body has two end-covers; each end-cover has a socket on the inner surface thereof and a through-hole penetrating the socket. Each terminal assembly has a screw and a fastener. The screw is inserted through the through-hole and has a head accommodated in the socket. The fastener is engaged with the screw from the outside of the end-cover to lock a wire or an electric-conduction plate in between the fastener and the battery body, whereby the wire or the electric-conduction plate is unlikely to loosen, wherefore the present invention is suitable for mobile products or frequently-vibrating products. Further, the present invention has simple structure and is suitable for low-cost standardized production.

### BACKGROUND OF THE INVENTION

1. Field of the Invention

The present invention relates to a novel secondary battery structure, particularly to a secondary battery structure, which has simple structure and reliable electric-connection structure and is suitable for standardized production.

2. Description of the Related Art

As the secondary battery has high energy and can be used repeatedly, many products, such as electric handheld tools, electric vehicles, electric motorcycles, and 3C products, are powered by the secondary battery. Considering cost and leakproofness, the secondary batteries are usually packaged into a sealed cylinder except some special secondary batteries. When high current is required, the cylindrical secondary batteries are stacked to assemble together, and wires or electric-conduction plates are used to connect terminals of the secondary batteries in series or in parallel with a spot welding method. Then, the secondary batteries are packaged into a battery module for high current application. Such a battery module has better heat radiation because of the gaps therebetween. Further, the assemblage thereof is economical.

However, the products using secondary batteries, including the products as small as a camera or as giant as an electric vehicle, are normally mobile devices, which are frequently vibrated. For the conventional spot welding method, the spot weld points of wires and electric-connection plates are likely to be loosened by frequent vibration. Further, the greater the current is needed, the more the batteries are spot welded together, and the higher the defective fraction will be. Besides, increasing spot weld points degrades current output.

Accordingly, the present invention proposes a secondary battery structure to improve the reliability of the serial/parallel connection structure of secondary batteries and overcome the conventional problems.

### SUMMARY OF THE INVENTION

The primary objective of the present invention is to provide a secondary battery structure, which has high-reliability serial connection structure and high-reliability parallel connection structure, whereby the yield is promoted, and whereby the present invention is suitable for mobile products and frequently-vibrating products.

Another objective of the present invention is to provide a secondary battery structure, which is simple-structured and suitable for mass production, low-price production and streamline production.

To achieve the abovementioned objectives, the present invention proposes a secondary battery structure, which comprises a battery body and two terminal assemblies. The battery body has two end-covers. Each end-cover has a socket on the inner surface thereof and a through-hole penetrating the end-cover. Each terminal assembly has a screw and a fastener able to engage with the screw. The screw passes through the through-hole of the end-cover. The screw has a head accommodated in the socket of the end-cover. The fastener engages with the screw from the outside. Thereby, the external wire can be firmly fixed in between the fastener and the battery body. Thus is promoted the reliability of the electric connection of the battery.

Below, the embodiments are described in detail in cooperation with the attached drawings to make easily understood the objectives, technical contents, characteristics and accomplishments of the present invention.

### BRIEF DESCRIPTION OF THE DRAWINGS

FIG. 1 is a diagram schematically showing a secondary battery structure according to one embodiment of the present invention; and

FIG. 2 is a diagram schematically showing that the secondary battery structures are series-parallel connection according to one embodiment of the present invention.

### DETAILED DESCRIPTION OF THE INVENTION

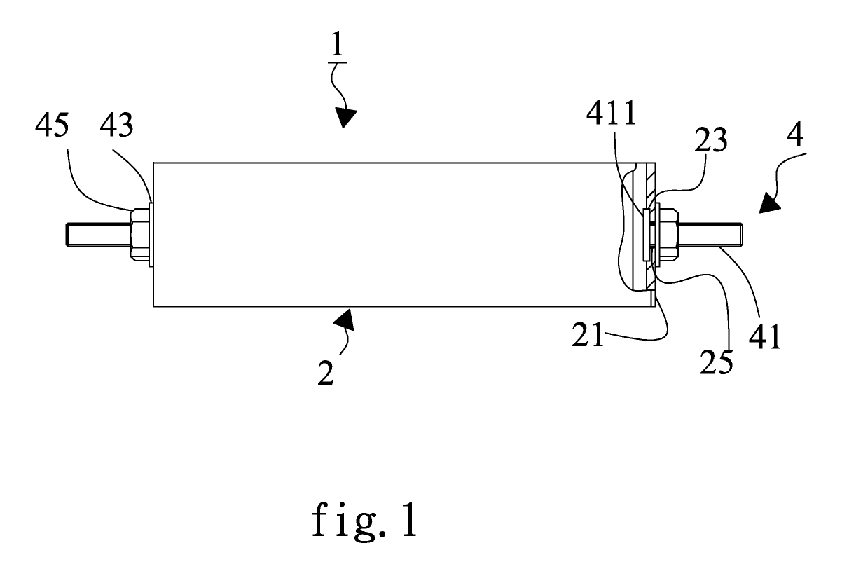

Refer to FIG. 1 a diagram schematically showing a secondary battery structure according to one embodiment of the present invention. The secondary battery structure 1 of the present invention comprises a battery body 2 and two terminal assemblies 4. The battery body 2 has a cylindrical shape and is packaged with an aluminum casing. Each end of the battery body 1 has an end-cover 21. A hexagonal socket 23 is formed on the inner surface of the end-cover 21, and a circular through-hole 25 is formed on the center of the socket 23. The battery body 2 may be a nickel-hydrogen battery, a nickel-cadmium battery, a lithium battery, or the attention-attracting lithium-iron-phosphate battery. The battery body 2 applies to digital cameras, electric tools, electric vehicles, electric motorcycles, or electric bikes. The internal structure of the battery body 2 varies with the application thereof. However, the internal structure of the battery body 2 is not the focus of the present invention, and it will not be described further herein. Each terminal assembly 4 includes a screw 41, a washer 43 and a fastener 45. The screw 41 is electrically-conductive and has a head 411 at one end thereof. The head 411 usually has a hexagonal shape and an appropriate thickness. In this embodiment, the fastener 45 is a nut able to engage with the screw 41.

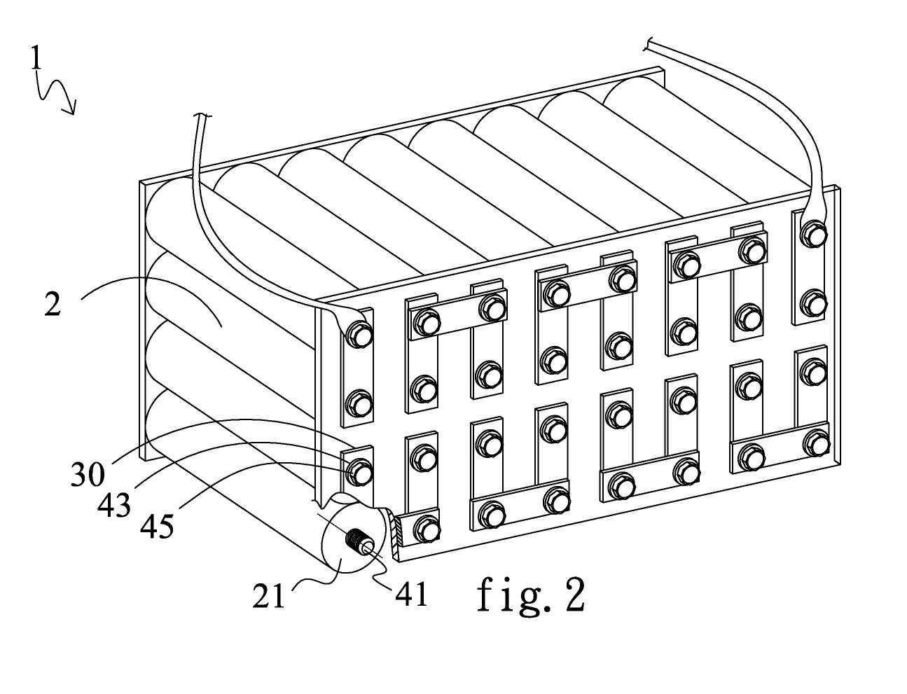

In assemblage, the screw 41 is inserted through the through-hole 25 of the end-cover 21, and let the head 411 of the screw 41 be accommodated in the socket 23 of the end-cover 21. As the head 411 and the socket 23 have the polygonal shapes corresponding to each other, the screw 41 is limited by the socket 23 and unable to rotate in the socket 23. The shapes of the head 411 and the socket 23 are not necessarily hexagonal. Any shape able to limit the rotation of the screw 41 is adoptable for the head 411 and the socket 23. After the end-covers 21 are joined to the battery body 2, two screws 41 are respectively electrically connected to the positive and negative electrodes of the battery body 2. Next, the screws 41 are sleeved by the washers 43 from the outside of the end-covers 21 and then secured by the fasteners 45. Thus is completed the secondary battery structure 1 of the present invention. Refer to FIG. 2 for an application of the present invention. When a high power output is needed, a plurality of the secondary battery structures 1 is stacked to achieve the function, wherein wires or electric-conduction plates 30 are locked onto the battery bodies by the fasteners 45. The washer 43 can distribute the stress of the fastener 45 uniformly lest the end-cover 21 be deformed. Different quantities of the secondary battery structures 1 are series-parallel connection and provide different current outputs and different voltage outputs (12V, 24V, 48V, etc.).

In conclusion, the secondary battery structure can provide more reliable electric-connection structure, which not only solves the conventional problem that the spot weld points are likely to be separated by vibration but also overcomes the problem of imperfect contacts. Therefore, the present invention is suitable for mobile products and frequently-vibrating products. Further, the output quality of the secondary battery structures of the present invention is not affected by increasing the stacked batteries. Furthermore, the present invention is also suitable for low-cost production, mass production, and standardized production because of the simple structure thereof.

The embodiments described above are to exemplify the present invention to enable the persons skilled in the art to understand, make and use the present invention. However, it is not intended to limit the scope of the present invention. Any equivalent modification or variation according to the spirit of the present invention is to be also included within the scope of the present invention.

What is claimed is:

1. A secondary battery structure, comprising a battery body and two terminal assemblies respectively arranged at two ends of said battery body, and characterized in
that said battery body has two end-covers, wherein each of said end-covers has a socket on an inner surface thereof and a through-hole penetrating said socket, and
that each of said terminal assemblies has a screw and a fastener, wherein said screw is inserted through said through-hole, and said screw has a head accommodated in said socket, and said fastener is engaged with said screw from outside of each of said end-covers.

2. The secondary battery structure according to claim 1, wherein said socket of each of said end-covers has a polygonal shape, and said head of said screw has a shape corresponding to that of said socket.

3. The secondary battery structure according to claim 1, wherein each of said terminal assemblies has a washer interposed between said fastener and one of said end-covers.

4. The secondary battery structure according to claim 1, wherein said fastener of each of said terminal assemblies is a nut.
